(19) United States
(12) Patent Application Publication
(10) Pub. No.: US 2014/0186077 A1
(43) Pub. Date: Jul. 3, 2014

(54) FIXING DEVICE AND ELECTROPHOTOGRAPHIC IMAGE FORMING APPARATUS HAVING THE SAME

(71) Applicant: SAMSUNG ELECTRONICS CO., LTD., Suwon-si (KR)

(72) Inventors: Sun-hyung LEE, Yangyang-gun (KR); Takashi Kidokoro, Suwon-si (KR); Yasumasa Otsuka, Seongnam-si (KR)

(21) Appl. No.: 13/920,827

(22) Filed: Jun. 18, 2013

(30) Foreign Application Priority Data
Dec. 27, 2012 (JP) 10-2012-0155325

(51) Int. Cl. G03G 15/20

(52) U.S. Cl. CPC G03G 15/2017
USPC 399/329

(57) ABSTRACT

A fixing device is provided. The fixing device includes a backup member that is disposed outside an endless belt that is flexible and rotates to rotate the endless belt, a nip forming member that is disposed inside the endless belt and faces the backup member to form a fixing nip, and a heater that includes a heating layer including an electroconductive filler dispersed in a base polymer to form an electroconductive network and that is interposed in a position corresponding to the fixing nip between the nip forming member and the endless belt.

### CROSS-REFERENCE TO RELATED APPLICATIONS

This application is related to, and claims priority to, Korean Patent Application No. 10-2012-0155325, filed on Dec. 27, 2012, in the Korean Intellectual Property Office, the disclosure of which is incorporated herein in its entirety by reference.

### BACKGROUND

1. Field

Embodiments of the present disclosure relate to a fixing device using a rotating endless belt and an electrophotographic image forming apparatus having the same.

2. Description of the Related Art

An image forming apparatus using an electrophotographic method supplies toner to an electrostatic latent image formed on an image receptor to form a visible toner image on the image receptor, transfers the visible toner image to a recording medium, and fixes the transferred toner image onto the recording medium. The toner may be manufactured by adding various types of functional additives including coloring to a base resin. A fixing process includes a process of applying heat and pressure to the toner.

In general, a fixing device includes a heating roller and a pressure roller that are engaged with each other to form a fixing nip. The heating roller is heated by a heat source such as a halogen lamp or the like. When the recording medium to which the toner is transferred passes through the fixing nip, heat and pressure are applied to the toner. Since the heat source may use air as a medium to heat the heating roller in the fixing device, high heat efficiency is difficult to achieve. As the halogen lamp emits more visible rays, which do not contribute to heating, than infrared rays that are more effective in terms of heating, a large amount of power is consumed. In addition, a roller-shaped body to be heated, i.e., the heating roller has a large heat capacity and thus is not effective in facilitating a fast temperature rise.

### SUMMARY

Additional aspects and/or advantages will be set forth in part in the description which follows and, in part, will be apparent from the description, or may be learned by practice of the invention.

According to an aspect of exemplary embodiment of the present invention, a fixing device is provided enabling a fast temperature rise and an image forming apparatus having the same.

According to an aspect of exemplary embodiment of the present invention, a fixing device is provided having an improved design degree of freedom in forming a fixing nip and an image forming apparatus having the same.

According to an aspect of an exemplary embodiment of the present invention, a fixing device is provided including an endless belt that rotates, a backup member that is disposed outside the endless belt to rotate the endless belt, a nip forming member that is disposed inside the endless belt and faces the backup member to form a fixing nip, and a heater interposed in a position corresponding to the fixing nip between the nip forming member and the endless belt to heat the endless belt, the heater including a heating layer including a base polymer and an electroconductive filler dispersed in the base polymer to form an electroconductive network in the base polymer.

The heater may contact an inner side of the endless belt.

A heat conductive plate may be interposed between the heater and the endless belt.

A width of the heat conductive plate may be greater than a width of the fixing nip.

The fixing nip may include at least two nip areas having different inclination angles.

A protrusion area may be formed around an exit of the fixing nip and protrudes toward the backup member.

The heater may extend to a position corresponding to the protrusion area.

A heat conductive plate may be interposed between the heater and the endless belt and may extend to a position corresponding to the protrusion area.

The heater may include a first insulating layer that includes a side supported by the nip forming member and another side on which the heating layer is formed, an electrode that is interposed between the heating layer and the first insulating layer, and a second insulating layer that covers the heating layer.

The second insulating layer may cover a part of the electrode.

The first insulating layer and the base polymer may be formed of the same type of material.

According to an aspect of the present invention, there is provided an image forming apparatus including: a printing unit that forms a visible toner image on a recording medium; and the fixing device that fixes the visible toner image onto the recording medium.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating an electrophotographic image forming apparatus according to an exemplary embodiment of the present invention;

FIG. 2 is a cross-sectional view illustrating a fixing device applied to an electrophotographic image forming apparatus, according to an exemplary embodiment of the present invention;

FIG. 3A is a cross-sectional view of an endless belt according to an exemplary embodiment of the present invention;

FIG. 3B is a cross-sectional view of an endless belt according to an exemplary embodiment of the present invention;

FIG. 4 is a cross-sectional view of a heater according to an exemplary embodiment of the present invention;

FIG. 5 is a cross-sectional view illustrating a fixing device including a belt, a heater, and a heat conductive plate interposed between the belt and the heater, according to an exemplary embodiment of the present invention;

FIG. 6 is a cross-sectional view of a fixing device according to an exemplary embodiment of the present invention;

FIG. 7 is a cross-sectional view illustrating a fixing device including a belt, a heater, and a heat conductive plate interposed between the belt and the heater, according to an exemplary embodiment of the present invention;

FIG. 8 is a cross-sectional view illustrating a fixing device according to an exemplary embodiment of the present invention; and

FIG. 9 is a cross-sectional view illustrating a fixing device including a belt, a heater, and a heat conductive plate interposed between the belt and the heater, according to an exemplary embodiment of the present invention.

### DETAILED DESCRIPTION

The present invention is disclosed with reference to the accompanying drawings, in which exemplary embodiments of the present invention are illustrated.

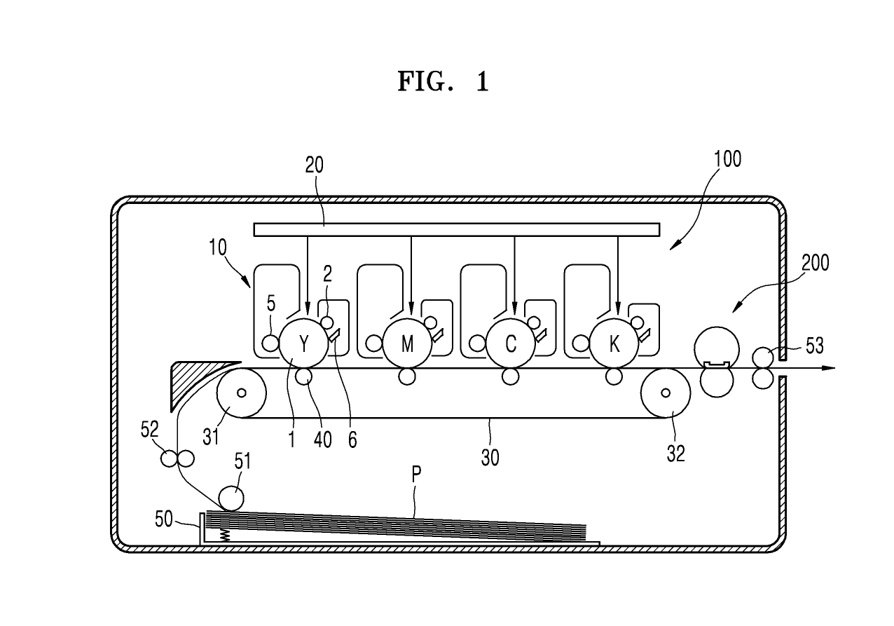

FIG. 1 is a schematic view illustrating an electrophotographic image forming apparatus according to an exemplary embodiment of the present invention. Referring to FIG. 1, the electrophotographic image forming apparatus includes a printing unit 100 that forms a visible toner image on a recording media P, e.g., a paper sheet, and a fixing device 200 that fixes the visible toner image onto the recording media P. The printing unit 100 of an exemplary embodiment forms a color toner image through an electrophotographic method.

The printing unit 100 includes a plurality of photoconductive drums 1, a plurality of developers 10, and a paper transporting belt 30. The photoconductive drums 1 are photoreceptors having surfaces on which electrostatic latent images are formed and include conductive metal pipes and photosensitive layers formed on outer surfaces of the conductive metal pipes. The plurality of developers 10 respectively correspond to the plurality of photoconductive drums 1 and supply the toner to the electrostatic latent images formed on the plurality of photoconductive drums 1 to develop the electrostatic latent images in order to form toner images on surfaces of the plurality of photoconductive drums 1. The plurality of developers 10 may be respectively replaced separately from the plurality of photoconductive drums 1. The plurality of developers 10 may respectively be in the form of cartridges including the photoconductive drums 1.

For color printing, the plurality of developers 10 includes a plurality of developers 10Y, 10M, 10C, and 10K containing yellow (Y), magenta (M), cyan (C), and black (K) color toners, respectively. However, the invention is not limited thereto, and developers containing various colors of toners such as light magenta, white, etc. besides the above-mentioned colors may be further included. An image forming apparatus including the plurality of developers 10Y, 10M, 10C, and 10K is disclosed. Unless indicated otherwise herein, elements denoted by the reference characters Y, M, C, and K refer to elements for printing an image by using Y, M, C, and K color toners.

The developer 10 supplies the toner contained therein to the electrostatic latent image formed on the photoconductive drum 1 to develop the electrostatic latent image as the visible toner image. The developer 10 may include a developing roller 5. The developing roller 5 supplies the toner of the developers 10 to the photoconductive drums 1. A developing bias voltage may be applied to the developing roller 5. A regulating member (not shown) regulates an amount of toner supplied to developing area where the photoconductive drum 1 and the developing roller 5 face each other, by the developing rollers 5.

If a two-component developing method is used, magnetic carrier may be in the developer 10, and the developing roller 5 rotates while keeping a distance, for example, in the order of tens to hundreds of microns from the photoconductive drum 1. Although not shown in FIG. 1, the developing roller 5 may have a shape in which a magnetic roller is arranged in a hollow cylindrical sleeve. The toner sticks onto surface of the magnetic carrier. The magnetic carrier sticks onto the surface of the developing roller 5 to be transferred to the developing area. Only the toner is supplied to the photoconductive drum 1 due to the developing bias voltage applied between the developing roller 5 and the photoconductive drum 1 to develop the electrostatic latent image formed on the surface of the photoconductive drum 1 as the visible toner image. If the two-component developing method is used, the developer 10 may include an agitator (not shown) for mixing and agitating the toner with carrier and transporting the mixed toner and carrier to the developing rollers 5. The agitator may be an auger, and a plurality of the agitators may be included in the developer 10.

If a one-component developing method that does not use a carrier is used, the developing roller 5 may rotate in contact with the photoconductive drum 1 or rotate at a position separate from the photosensitive drum 1 in the order of tens to hundreds of microns. The developer 10 may further include a supplying roller (not shown) that sticks the toner onto the surface of the developing roller 5. A supply bias voltage may be applied to the supplying roller. The developer 10 may further include an agitator (not shown). The agitator may agitate and tribo-electrify the toner. The agitator may be an auger.

The charging roller 2 is an example of a charger that charges the photoconductive drum 1 so that the photoconductive drum 1 have uniform surface potential. A charging brush, a corona charger, or the like may be used instead of the charging roller 2.

A cleaning blade 6 is an example of a cleaning device that removes toner and foreign matter remaining on the surface of the photoconductive drum 1 after a transferring process. Instead of the cleaning blade 6, other types of cleaning device such as rotating brush or the like may be used.

An example of a developing method of an image forming apparatus according to an exemplary embodiment of the invention is described in detail. However, the invention is not limited thereto the developing method may be variously modified.

An exposer 20 irradiates light modulated to correspond to image information onto photoconductive drums 1Y, 1M, 1C, and 1K to form electrostatic latent images respectively corresponding to Y, M, C, and K color images on the photoconductive drums 1Y, 1M, 1C, and 1K. Representative examples of the exposer 20 may include a laser scanning unit using a laser diode as a light source, a light-emitting diode (LED) exposer using an LED as a light source, etc.

The paper-transporting belt 30 supports and transports the recording media P. The paper-transporting belt 30 may be supported by, for example, support rollers 31 and 32, and circulates. A plurality of transfer rollers 40 may be disposed to respectively face the plurality of photoconductive drums 1Y, 1M, 1C, and 1K with the paper-transporting belt 30 therebetween. The plurality of transfer rollers 40 are examples of a transfer unit that transfers the toner images from the plurality of photoconductive drums 1Y, 1M, 1C, and 1K to the recording media P supported by the paper transfer belt 30. A transfer bias voltage is applied to the plurality of transfer rollers 40 to transfer the toner images to the recording media P. A corona transfer unit or a pin scorotron type transfer unit may be used instead of the transfer rollers 40.

The recording media P may be picked up from a loading station 50 by a pickup roller 21 and transported by a transporting roller 51, and may be attached to the paper-transporting belt 30 by an electrostatic force.

The fixing device 200 applies heat and/or pressure to the toner image transferred to the recording media P to fix the toner image onto the recording medium P. The recording medium P passing through the fixing device 200 is discharged by a discharge roller 53.

According to an exemplary embodiment, the exposer 20 scans a plurality of light rays, which are modulated to correspond to image information of colors, onto the plurality of photoconductive drums 1Y, 1M, 1C, and 1K to form the electrostatic latent images. A plurality of developers 10Y, 10M, 100, and 10K respectively supply Y, M, C, and K color toners to the electrostatic latent images on the plurality of photoconductive drums 1Y, 1M, 1C, and 1K to form Y, M, C, and K color visible toner images on the surfaces of the plurality of photoconductive drums 1Y, 1M, 1C, and 1K. The recording medium P loaded on the loading station 50 may be fed to the paper-transporting belt 30 through the pickup roller 51 and the transporting roller 52 and maintained on the paper-transporting belt 30 by the electrostatic force. The Y, M, C, and K color toner images may be sequentially transferred onto the recording medium P, which is transported by the paper transfer belt 30, due to the transfer bias voltage applied to the transfer rollers 40. If the recording medium P passes through the fixing device 200, the toner images are fixed on the recording medium P by heat and pressure. The recording medium P on which the fixing is completed is discharged by the discharge roller 53.

The electrophotographic image forming apparatus of FIG. 1 uses a method of directly transferring the toner images developed on the plurality of photoconductive drums 1Y, 1M, 1C, and 1K to the recording medium P supported by the paper-transporting belt 30. However, the scope of the invention is not limited to this. For example, the electrophotographic image forming apparatus may use an intermediate transfer method in which the toner images developed on the plurality of photoconductive drums 1Y, 1M, 1C, and 1K are intermediately transferred to an intermediate transfer belt and then transferred to the recording medium P.

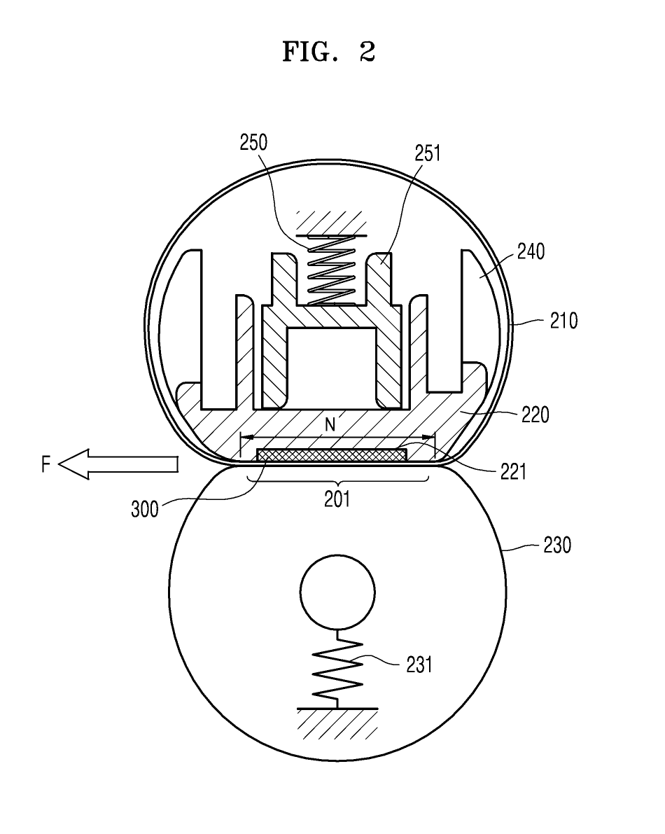

The fixing device 200 applies heat and/or pressure to the toner images to fix the toner images onto the recording medium P. A heat capacity of a heated part of the fixing device 200 may be small to improve a printing speed and reduce energy consumption. Accordingly, the fixing device 200 may use a thin film-shaped endless belt as the heated part. FIG. 2 is a cross-sectional view of a fixing device, for example, fixing device 200 according to an exemplary embodiment of the invention.

Referring to FIG. 2, a fixing device, for example, fixing device 200 includes an endless belt 210, a nip forming member 220 that is positioned inside the endless belt 210, and a backup member 230 that is positioned outside the endless belt 210 to be opposite to the nip forming member 220 in order to form a fixing nip 201. The backup member 230 may be pressurized with respect to the nip forming member 220 with the endless belt 210 therebetween and rotates in order to rotate the endless belt 210.

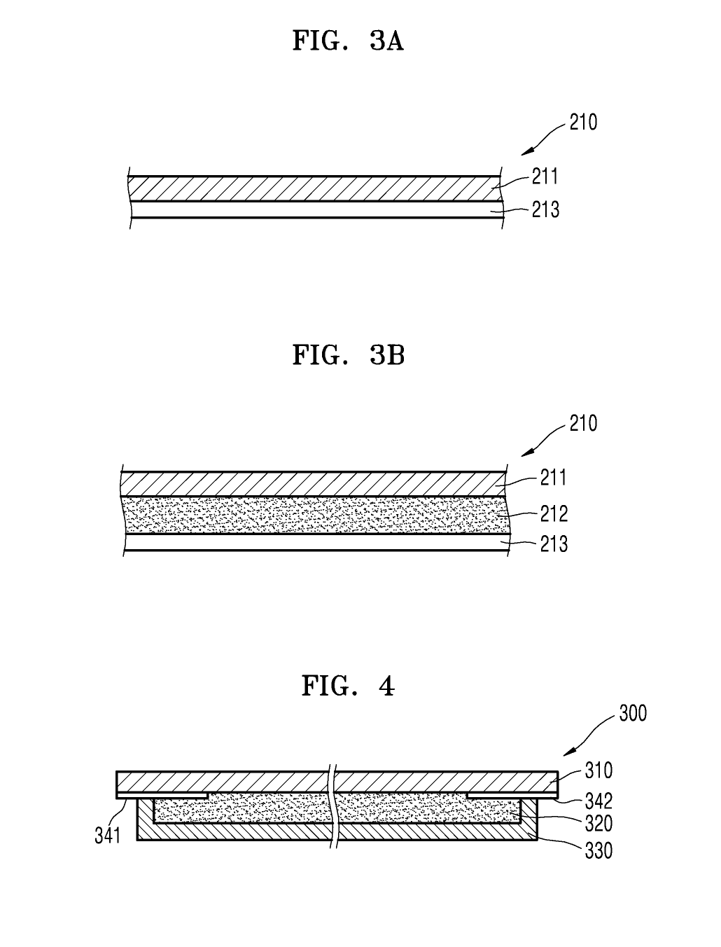

FIG. 3A is a cross-sectional view of the endless belt 210 according to an exemplary embodiment of the invention. Referring to FIG. 3A, the endless belt 210 includes a substrate 211 having a film form. The substrate 211 may be a metal thin film such as a stainless steel thin film and a nickel thin film, or a polymer film having a heat resistance and a wear resistance at a fixing temperature, e.g., a temperature range of about 120° C.˜200° C., such as a polyimide film, a polyamide film, a polyimideamide film, or the like. A thickness of the substrate 211 may be determined so that the endless belt 210 has flexibility and elasticity to be capable of being flexibly deformed on the fixing nip 201 and returning to its original state after leaving the fixing nip 201. For example, the thickness of the substrate 211 may be between about 30 μm and about 200 μm. As an embodiment, the thickness of the substrate 211 may be between about 75 μm and about 100 μm.

An outermost layer of the endless belt 210 may be a release layer 213. An offset, in which toner on the recording medium P melts in a fixing process and attaches to the endless belt 210, may occur. The offset may cause a printing defect whereby a part of a printed image on the recording medium P is omitted or a jam in which the recording medium P getting out of the fixing nip 201 is not separated from the endless belt 210 and sticks on an outer surface of the endless belt 210. The release layer 213 may be a resin layer having high separation characteristics. The release layer 213 may be, for example, one of perfluoroalkoxy (PFA), polytetrafluoroethylenes (PTFE), and fluorinated ethylene prophylene (FEP), a blend of two or more thereof, or a copolymer thereof. The release layer 213 may be formed by covering a tube with the material on the substrate 211 or coating the material on a surface of the substrate 211. A thickness of the release layer 213 may be between about 10 μm to about 30 μm.

As illustrated in FIG. 3B, the endless belt 210 may include an elastic layer 212. The elastic layer 212 may be interposed between the substrate 211 and the release layer 213. The elastic layer 212 may be used to easily form the fixing nip 201 and may be formed of a material having a heat resistance to fixing temperature. For example, the elastic layer 212 may be formed of a rubber material such as a fluoro rubber, a silicon rubber, a natural rubber, an isoprene rubber, a butadiene rubber, a nitrile rubber, a chloroprene rubber, a buthyle rubber, an acrylic rubber, a hydrin rubber, a urethane rubber, or the like. The elastic layer 212 may be formed of one of various types of elastomers, such as of a stylene group, a polyurethane group, a polyester a group, a polyamide group, a polybutadiene group, a transpolyisoprene group, a chlorinated polyethylene group, etc., a blend thereof, or a copolymer thereof. A thickness of the elastic layer 212 may be between about 10 μm to 100 μm.

The nip forming member 220 may be arranged inside the rotating endless belt 210. The backup member 230 may be arranged outside the rotating endless belt 210 to be opposite to the nip forming member 220. The nip forming member 220 and the backup member 230 are pressurized with respect to each other so that the endless belt 210 is interposed therebetween. For example, a pressure pushing toward the backup member 230 may be applied to both ends of the nip forming member 220 in a longitudinal direction orthogonal to a rotating direction of the endless belt 210 through a first pressuring member, e.g., a spring 250. As illustrated in FIG. 2, the spring 250 interposes a pressurizing bush 251 to pressurize the nip forming member 220. A pressure pushing toward the nip forming member 220 may be applied to the backup member 230 through a second pressuring member, e.g., a spring 231. The backup member 230 may rotate the endless belt 210. For example, the backup member 230 may be a pressurizing roller including an elastic layer formed on an outer surface of a metallic core. The back-up member 230 may rotate the endless belt 210 by rotating in a pressed state, having the endless belt 210 disposed between the back-up member 230 and the nip forming member 220. The nip forming member 220 and the backup member 230 may form the fixing nip 201 and guide the endless belt 210 to rotate. A belt guide 240 may be provided outside the fixing nip 201 to the rotating endless belt 210 to smoothly rotate. The belt guide 240 may be formed integrally with the nip forming member 220 or may be installed separately from the nip forming member 220.

A heater 300 may be disposed at a side of the nip forming member 220 toward the fixing nip 201. According to an exemplary embodiment, a concave part 221 may be provided on a surface of the nip forming member 220 positioned toward the fixing nip 201, and the heater 300 may be disposed in the concave part 221. For example, the heater 300 may be fixed into the concave part 221 through a method such as bonding or the like. The heater 300 according to an exemplary embodiment may be flexible. FIG. 4 is a cross-sectional view of an exemplary heater, e.g., heater 300 according to an exemplary embodiment of the invention. Referring to FIG. 4, the heater 300 may include a first insulating layer (a substrate) 310, a heating layer 320, and a second insulating layer 330. Electrodes 341 and 342 may be respectively positioned on both ends of the first insulating layer 310 in a longitudinal manner to supply a current to the heating layer 320. The electrodes 341 and 342 may be formed of a low resistance metal. The heating layer 320 may be positioned on the first insulating layer 310 and the electrodes 341 and 342. The second insulating layer 330 may be positioned on the heating layer 320. The second insulating layer 330 covers the heating layer 320 and parts of the electrodes 341 and 342. Parts of the electrodes 341 and 342 may be exposed to be connected to a power supply device (not shown).

The first and second insulating layers 310 and 330 may be polymer layers that have high heat resistance and electrical insulating properties. For example, the first and second insulating layers 310 and 330 may be polyimide (PI) resin layers. The first and second insulating layers 310 and 330 may have a withstand voltage of about 3 kV or more. A thickness of a polyimide resin layer may be between about 20 μm and about 70 μm. As a result of evaluating a withstand voltage, the polyimide resin layer may have a withstand voltage of about 3 kV or more at a thickness of about 20 μm. Therefore, the thickness of the polyimide resin layer may be about 20 μm or more in consideration of the withstand voltage characteristics. Also, the thickness of the polyimide resin layer may be about 70 μm in consideration of a heat conduction characteristic. According to an exemplary embodiment, the thickness of the polyimide resin layer that acts as the first insulating layer 310 may be between about 20 μm and about 50 μm.

The heating layer 320 may include a base polymer and an electroconductive filler dispersed in the base polymer. A base polymer having a heat resistance to a fixing temperature may be used. For example, the base polymer may be a heat-resistant resin or a heat-resistant elastomer. The heat-resistant resin may be polyimide, polyimideamide, or the like. The heat-resistant elastomer may be a silicon elastomer, a fluoric elastomer, or the like. The base polymer may be one of the above-described materials, a blend of two or more thereof, or a copolymer thereof.

One or more kinds of electroconductive filter may be dispersed in the base polymer. A metallic filler and a carbonic filler may be used as the electroconductive filler. The carbonic filler may include a carbon black, a carbon nanotube (CNT), a cup-stacked carbon nanotube, a carbon fiber, a carbon nanofiber, a carbon nanocoil, fullerene, graphite, expanded graphite, graphite nano platelet, graphite oxide (GO), etc. The electronconductive filler may be one of them or a combination of two or more of them.

The electroconductive filler may be dispersed in the base polymer to form an electroconductive network. Therefore, the heating layer 320 may be an electric conductor or a resistor. For example, a CNT has an electric conductivity similar to metal and a very low density, a heat capacity per unit volume of the CNT is 3 to 4 times lower than that of a general resistance material. This indicates that the heating layer 320 using the CNT as the electroconductive filler rapidly changes a temperature. Therefore, a heater, for example, heater 300 may be used to reduce a time required for transitioning from a standby mode to a printing mode, thereby enabling rapid first printing.

A thickness of the heating layer 320 may be changed by a resistance of the electronconductive filter, a resistance required for an entire part of the heater 300, etc. For example, the thickness of the heating layer 320 may be between about 50 μm and 300 μm. If a multi-walled carbon nanotube (MWNT) is used as the electroconductive filler, a content of the electroconductive filler may be between about 10 wt % and about 40 wt %, and the thickness of the heating layer 320 may be between about 100 μm and about 200 μm.

For example, the electrode 341 and 342 may be disposed on the first insulating layer 310, and the heating layer 320 and the second insulating layer 330 may be bonded thereon to form the heater 300. A conductive primer may be used for bonding between the electrodes 341 and 342 and the heating layer 320.

According to an exemplary embodiment, the electrodes 341 and 342 may be disposed on the first insulating layer 310. A solution in which a polymer precursor and the electroconductive filler are mixed and dispersed into a solvent may be coated on the first insulating layer 310 and the electrodes 341 and 342 and then thermally treated. In the thermal treating process, the solvent is dispersed and the polymer precursor is solidified to form a solid polymer. The solid polymer has a strong adhesive strength with respect to the electroconductive filler dispersed in the solid polymer to fix the electroconductive filler therein. Therefore, the electroconductive filler may be prevented from being moved in the solid polymer, and a structure of the electroconductive filler contributing to forming of an electroconductive network, e.g., a graphene structure (π-π* bond, is not destroyed. As a result, a heating body having a high reactivity (heating speed) with respect to an input voltage may be obtained. In this process, the heating layer 320 may be bonded to the electrodes 341 and 342 without using a conductive primer. Therefore, a heater may be manufactured in which a contact resistance between the heating layer 320 and the electrodes 341 and 342 is low, and an adhesive strength between the heating layer 320 and the electrodes 341 and 342 is high. The insulating layer 330 may be bonded to the first insulating layer 310, the heating layer 320, and the electrodes 341 and 342.

A base polymer of the heating layer 320 and the first insulating layer 310 may be the same material. Thus, a chemical affinity between the first insulating layer 310 and the heating layer 320 is increased to improve the adhesive strength between the first insulating layer 310 and the heating layer 320.

As illustrated in FIG. 2, the heater 300 may directly contact an inner side of the endless belt 210 to heat the endless belt 210. Accordingly, the heater 300 directly heats the endless belt 210 positioned between the heater 300 and the backup member 230, and thus heat loss is reduced, high heat efficiency is achieved, and power consumption is reduced. An endless belt 210 having a very small heat capacity may be used to enable a fast temperature rise. A lubricant, e.g., grease, may be coated between the endless belt 210 and the nip forming member 220 to reduce friction between the endless belt 210 and the nip forming member 220, thereby reducing abrasion between the endless belt 210 and the nip forming member 220 and a breakdown caused by the abrasion.

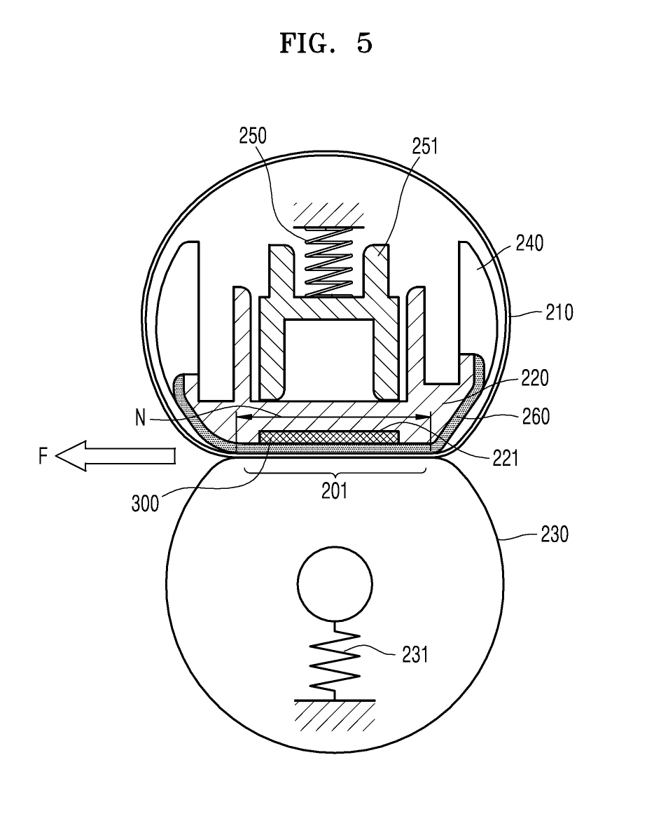

FIG. 5 is a cross-sectional view of a fixing device according to an exemplary embodiment of the invention. Referring to FIG. 5, a heat conductive plate 260 may be interposed between the heater 300 and the endless belt 210. The heat conductive plate 260 may be a metallic thin plate. The heat conductive plate 260 may be interposed between the heater 300 and the endless belt 210 to uniformly transmit heat of the heater 300 to the endless belt 210. A width of the heat conductive plate 260 may be equal to, or greater than, a width N of the fixing nip 201 to extend a range of a heat transmission to the recording medium P to further improve a fixing characteristic. The lubricant may be coated between the endless belt 210 and the heat conductive plate 260.

A ceramic heater (not shown) may be considered as a heater directly heating a belt in a fixing nip. The ceramic heater includes a metal heating-element pattern layer positioned on a ceramic substrate, and an insulating layer positioned on the metal heating-element pattern layer. Al₂O₃ or AlN may be used as the ceramic substrate, and an Ag—Pd alloy may be used as the metal heating-element pattern layer. A glass layer may be used as the insulating layer. An electrode for supplying a current to the metal heating-element pattern layer may be positioned on the ceramic substrate. The electrode may be connected to a power supply device through a connector or the like.

As formed of a ceramic substrate, the ceramic heater may be sensitive to pressure, and may be easily damaged due to an unbalanced pressing force. If an unbalance in the pressing force is caused, for example, by an uneven fixing nip or a relatively inaccurate pressure structure, the ceramic heater may be damaged. Since the heating-element pattern layer may be formed of a very thin metal film, an unbalance in the pressing force may cause to break the heating-element pattern layer and electrical disconnection of the heating-element pattern layer. Therefore, a design of a shape of the fixing nip and a pressure structure may be restricted.

With regard to a fixing apparatus that is controlled at a predetermined temperature, the ceramic heater may be severely deformed, that is, expanded or shrunk, by heat in an environment with drastic temperature changes. Therefore, the heat-element pattern layer in the form of a thin metal film may be broken. Heat deformation of a ceramic heater may cause friction between the electrode and a connector, thus resulting in abrasion of a surface of an electrode, excessive heating of the electrode, and thereby increasing a possibility of damaging the ceramic heater. Abrasion of the belt may be caused by friction between a surface of the expanded heater and the belt. Abrasion of the electrode and abrasion of the belt are very serious as being related to a stability of the fixing apparatus.

When a paper jam is generated, a pressing force for forming a fixing nip may be released in order to remove the paper. A pressing force may be applied to both ends of the ceramic heater. When the pressing force is released, a central part, in a direction of a length of the ceramic heater, may be deflected. When the paper is pulled and removed in this state, the belt and the central part of the ceramic heater may rub each other, thus damaging the belt and/or the ceramic heater.

With a flat fixing nip, removing a wrap jam in which paper, passing through the fixing nip, is not separated from the belt and is jammed in the belt may be difficult.

The fixing device of an exemplary embodiment may use the flexible heater 300. The flexible heater 300 may be barely damaged by an unbalance in pressure, and thus a precision of the pressurizing structure is lowered, and a structure of the fixing device is simplified. A flexible heater 300 may be freely expanded and shrunk by heat, and the deformation of the heating layer 320 caused by heat hardly affects the electrodes 341 and 342. Therefore, a friction possibility between the electrodes 341 and 342 and a power supplying connector (not shown) connected to the electrodes 341 and 342 is very low. The flexible heater 300 lowers damage to the belt due to friction, compared to the ceramic heater. A lubricant, e.g., grease, may be coated between the belt 210 and the heater 300 to further reduce the damage to the belt 210 caused by the friction with the belt 210.

According to a fixing apparatus that employs the flexible heater 300, the flexible heater 300 may be smoothly bent according to a shape of the fixing nip 201, and thus, a design freedom for the fixing nip 201 may be increased. Accordingly, the fixing nip 201 may be formed in various forms for improving heat efficiency and fixing characteristics. Additionally, various forms of the fixing nip 201, which are suitable for preventing a wrap jam to improve separation characteristics, may be implemented.

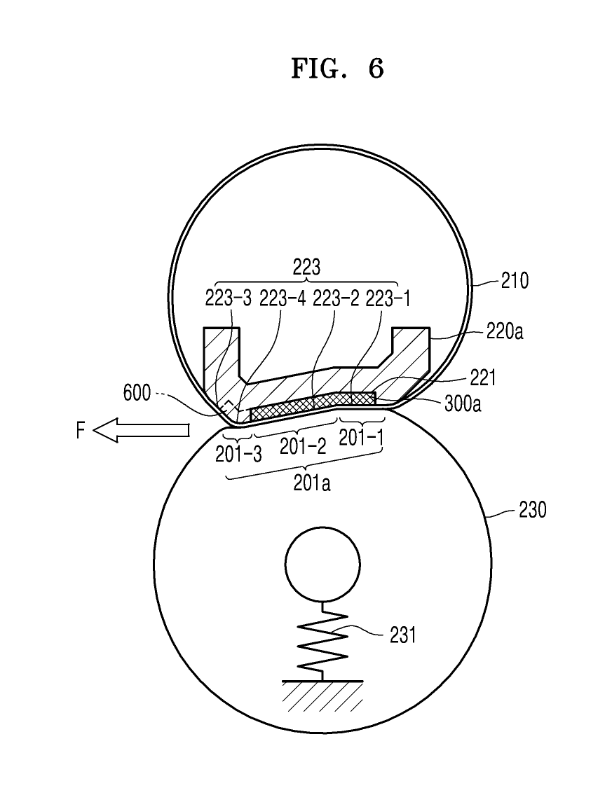

FIG. 6 is a cross-sectional view of a fixing device according to an exemplary embodiment of the present invention. Referring to FIG. 6, a flexible heater 300a may be disposed on a side of a fixing nip 201a of a nip forming member 220a. The flexible heater 300a may have a similar composition, but a different shape than the heater 300 illustrated in FIG. 4. The flexible heater 300a contacts an inner side of a belt 210 to directly heat the belt 210. A spring and a pressurizing bush that pressurize the nip forming member 220a toward a backup member 230 are not illustrated in FIG. 6.

The fixing nip 201a may be formed by being disposed between the nip forming member 220a and the backup member 230 and may include at least two areas that form an angle with each other. The at least two nip areas, which form an angle with each other, indicate that at least two nip areas are not the same flat or curved surface. In other words, angles of two nip areas with respect to a recording medium transporting direction F are different from each other. For example, the fixing nip 201a includes a first nip area 201-1 at an entrance and a second nip area 201-2 that forms an angle to the first nip area 201-1 and extends towards an exit. The first and second nip areas 201-1 and 201-2 may be inclined downwardly toward the backup member 230. The first and second nip areas 201-1 and 201-2 may have respectively plane shapes or curved shapes. The fixing nip 201a is not limited to the shape illustrated in FIG. 6 but may have various shapes capable of improving heat efficiency and a fixing characteristic in the fixing nip 201a. Since the heater 300a according to an exemplary embodiment is flexible, the heater 300a may be smoothly deformed according to the shape of the fixing nip 201a. Therefore, a degree of freedom of the shape of the fixing nip 201a may be improved, and the belt 210 may be uniformly heated in the fixing nip 201a which has an uneven shape.

A protrusion area 201-3 that protrudes toward the backup member 230 so that a curvature of the protrusion 201-3 rapidly varies may be provided around the exit of the fixing nip 201a. If the recording medium P is not separated from the belt 210 due to an adhesive strength between toner melt on the recording medium P and the belt 210 while the recording medium P passing through the fixing nip 201a, a wrap-jam may occur. However, the curvature of the belt 210 may rapidly vary at the exit of the fixing nip 201, and thus the recording medium P may be easily separated from the belt 210 due to a rigidity of the recording medium P. Therefore, a wrap jam, caused when the recording medium P passing through the fixing nip 201 is jammed in the belt 210, may be reduced.

According to an exemplary embodiment, the shape of the fixing nip 201a of FIG. 6 may be realized by a shape of the nip forming member 220a. Referring to FIG. 6, the nip forming member 220a may include a nip former 223 that faces the backup member 230 to form the fixing nip 201a. The nip former 223 may include a first nip former 223-1 and a second nip former 223-2 that forms an angle with respect to the first nip former 223-1. The first and second nip formers 223-1 and 223-2 respectively correspond to the first and second nip areas 201-1 and 201-2. The first and second nip formers 223-1 and 223-2 may be inclined downwards to the backup member 230. The first and second nip formers 223-1 and 223-2 may respectively have plane shapes or curved shapes. A concave part 221 may be formed on the first and second nip formers 223-1 and 223-2. The nip former 223 may include a third nip former 223-3 that extends from the second nip former 223-2 to an opposite side of the backup member 230, i.e., to the belt 210, to form a protrusion 223-4 protruding toward the backup member 230 between the second nip former 223-2 and the third nip former 223-3. The protrusion area 201-3, which protrudes towards the back-up member 230, may be formed near the exit of the fixing nip 201a by the protruding area 223-4.

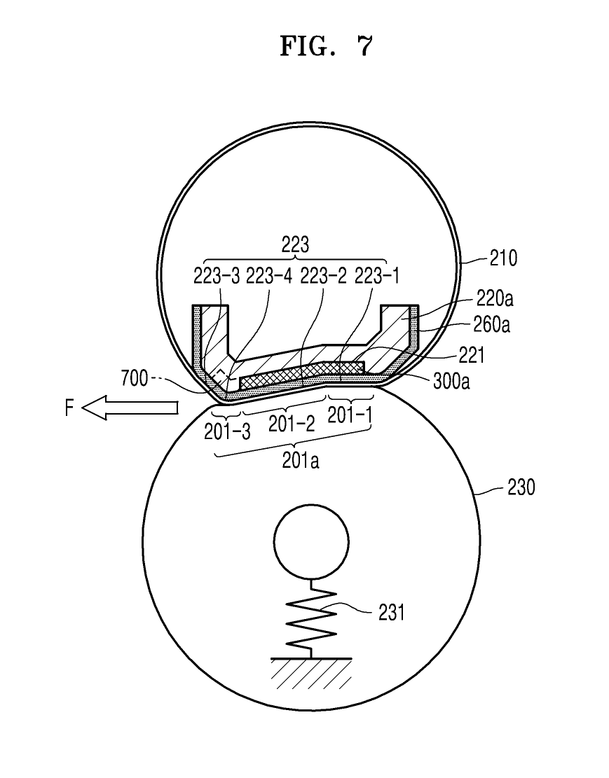

FIG. 7 is a cross-sectional view of a fixing device according to an exemplary embodiment of the invention. Referring to FIG. 7, the fixing device of the an exemplary embodiment similar to the fixing device of FIG. 6 except that a heat conductive plate 260a is interposed between a nip forming member 220a and a belt 210. The heat conductive plate 260a may be provided to at least correspond to the first and second nip areas 201-1 and 201-2. The heat conductive plate 260a may also extend to a position corresponding to the protrusion area 201-3. Therefore, heat from the heater 300a is transmitted to the protrusion area 201-3 to improve fixing and separation characteristics. The heat conductive plate 260a may be a metallic thin plate. The heat conductive plate 260a may be interposed between the heater 300a and the belt 210 to uniformly transmit the heat of the heater 300a to the belt 210. A width of the heat conductive plate 260a may be equal to, or wider than, a width N of the fixing nip 201a to extend a range of heat transmission to the recording medium P in order to improve the fixing characteristic.

As marked with dashed line 600 in FIG. 6 and dashed line 700 in FIG. 7, the heater 300a may extend at least to a position corresponding to the protrusion area 201-3 or may extend beyond the position. Therefore, heat may be effectively transmitted to the recording medium P even in the protrusion area 201-3. Therefore, fixing characteristics as well as separation characteristics may be improved.

In the fixing device according to the exemplary embodiments illustrated, for example, in FIGS. 2, 5, 6, and 7, the heater 300 or 300a may be positioned in the concave part 221 of the nip forming member 220 or 220a. However, the scope of the invention is not limited thereto.

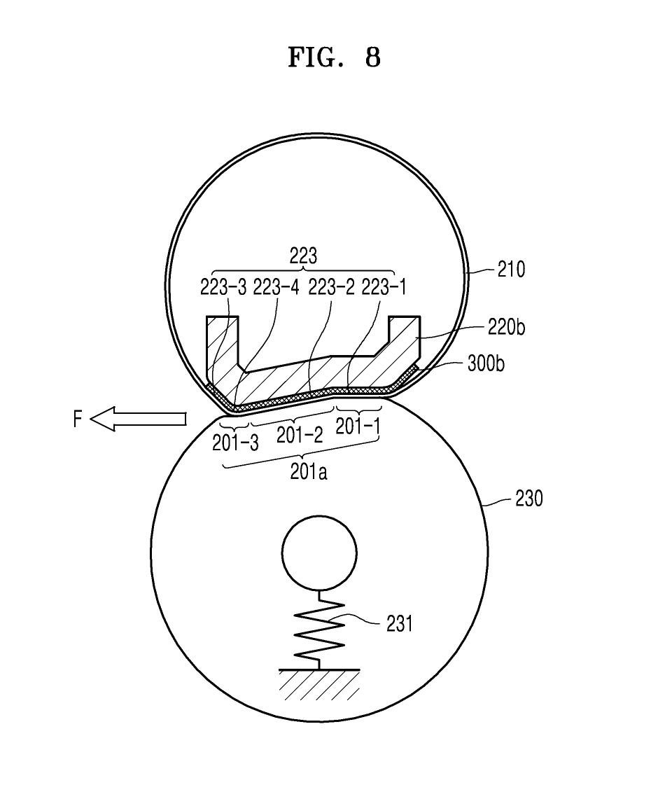

Referring to FIG. 8, a heater 300b may be disposed on a side of a nip forming member 220b positioned toward a fixing nip 201a to directly heat a belt 210. The nip forming member 220b is similar to the nip forming member 220a of FIG. 6 except that the nip forming member 220b does not include the concave part 221. In other words, a nip former 223 of the nip forming member 220b includes first, second, and third nip formers 223-1, 223-2, and 223-3, and a protrusion 223-4 to form the fixing nip 201a including first and second nip areas 201-1 and 201-2 and a protrusion area 201-3. Since the heater 300b is flexible, the heater 300b may be bent according to a shape of the nip former 223.

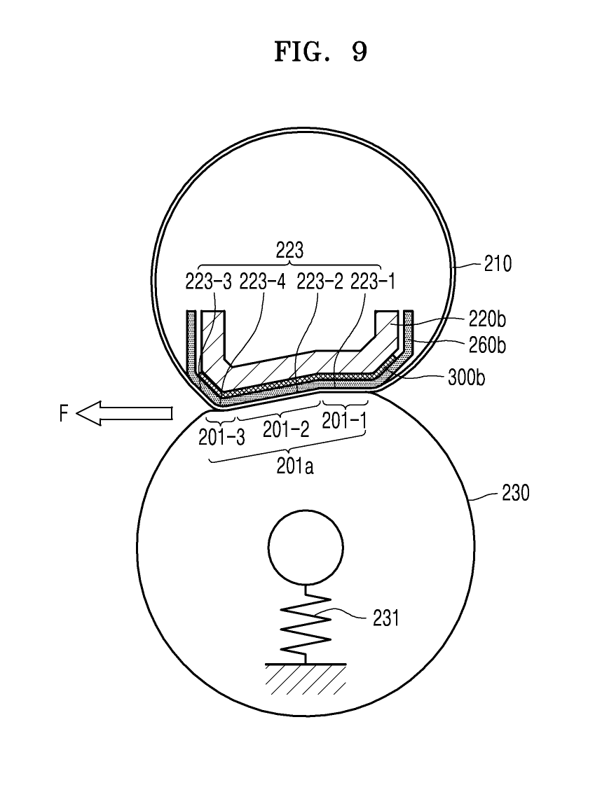

As illustrated in FIG. 9, a heat conductive plate 260b may be interposed between the nip forming member 220b and the belt 210 to uniformly transmit heat of the heater 300b to the belt 210. The heat conductive plate 260b may extend to an area corresponding to the protrusion area 201-3.

As illustrated in FIGS. 8 and 9, the heater 300b extends at least to the area corresponding to the protrusion area 201-3 to effectively transmit heat to the recording medium P in the protrusion area 201-3, thereby improving fixing and detachability characteristics.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A fixing device comprising:
an endless belt that rotates;
a backup member that is disposed outside the endless belt to rotate the endless belt; and
a nip forming member that is disposed inside the endless belt and faces the backup member to form a fixing nip; and
a heater interposed in a position corresponding to the fixing nip between the nip forming member and the endless belt to heat the endless belt, the heater comprising a heating layer including a base polymer and an electroconductive filler dispersed in the base polymer to form an electroconductive network in the base polymer.

2. The fixing device of claim 1, wherein the heater contacts an inner side of the endless belt.

3. The fixing device of claim 1, wherein a heat conductive plate is interposed between the heater and the endless belt.

4. The fixing device of claim 3, wherein a width of the heat conductive plate is greater than a width of the fixing nip.

5. The fixing device of claim 1, wherein the fixing nip comprises at least two nip areas having different inclination angles.

6. The fixing device of claim 5, wherein a protrusion area is formed around an exit of the fixing nip and protrudes toward the backup member.

7. The fixing device of claim 6, wherein the heater extends to a position corresponding to the protrusion area.

8. The fixing device of claim 6, wherein a heat conductive plate is interposed between the heater and the endless belt and extends to a position corresponding to the protrusion area.

9. The fixing device of claim 1, wherein the heater comprises:
a first insulating layer including a side supported by the nip forming member and another side on which the heating layer is formed;
an electrode that is interposed between the heating layer and the first insulating layer; and
a second insulating layer that covers the heating layer.

10. The fixing device of claim 9, wherein the second insulating layer covers a part of the electrode.

11. The fixing device of claim 9, wherein the first insulating layer and the base polymer are formed of the same type of material.

12. An image forming apparatus comprising:
a printing unit that forms a visible toner image on a recording medium; and
the fixing device of claim 1 that fixes the visible toner image onto the recording medium.

13. The image forming apparatus of claim 12, wherein the heater contacts an inner side of the endless belt.

14. The image forming apparatus of claim 12, wherein a heat conductive plate is interposed between the heater and the endless belt,
wherein the width of the heat conductive plate is greater than the width of the fixing nip.

15. The image forming apparatus of claim 12, wherein the fixing nip comprises at least two nip areas having different inclination angles.

16. The image forming apparatus of claim 15, wherein a protrusion area is formed around the exit of the fixing nip and protrudes toward the backup member.

17. The image forming apparatus of claim 16, wherein a heat conductive plate is interposed between the heater and the endless belt,
wherein the heater and the heat conductive plate extend to a position corresponding to the protrusion area.

18. The image forming apparatus of claim 12, wherein the heater comprises:
a first insulating layer that comprises a side supported by the nip forming member and another side on which the heating layer is formed;
an electrode that is interposed between the heating layer and the first insulating layer; and
a second insulating layer that covers the heating layer.

19. The image forming apparatus of claim 18, wherein the second insulating layer covers part of the electrode.

20. The image forming apparatus of claim 18, wherein the first insulating layer and the base polymer are formed of a same type of material.

21. A fixing device for an apparatus having a rotatable belt, the fixing device comprising:
a nip forming member that is disposed inside the rotatable belt and faces a backup member to form a fixing nip; and
a heater disposed in a position corresponding to the fixing nip to heat the rotatable belt, the heater having a flexible shape.
